(19) United States
(12) Patent Application Publication
(10) Pub. No.: US 2022/0411577 A1
(43) Pub. Date: Dec. 29, 2022

(54) IMPROVED POLYESTER

(71) Applicant: DUPONT POLYMERS, INC., Wilmington, DE (US)

(72) Inventors: Edward Maxwell de Brant Smith, Wilmington, DE (US); Pijush Dewanjee, Carlsbad, CA (US); John Gilbert Guard, Oceanside, CA (US)

(21) Appl. No.: 17/754,665

(22) PCT Filed: Oct. 8, 2020
(86) PCT No.: PCT/US2020/054755

§ 371 Date: Apr. 8, 2022

Related U.S. Application Data
(60) Provisional application No. 62/912,716, filed on Oct. 9, 2019.

(51) Int. Cl. C08G 63/91; C08G 18/76; C08G 18/08; C08G 18/42; C08G 18/48; C08G 18/38; C08G 18/66

(52) U.S. Cl. CPC C08G 63/916; C08G 18/7671; C08G 18/0895; C08G 18/4252; C08G 18/4887; C08G 18/3814; C08G 18/6651; C08G 18/6685

(57) ABSTRACT

The invention provides a method for the production of a cross-linked polyester moulded article.

### FIELD OF INVENTION

The present invention relates to the field of polyesters, particularly copolyetheresters.

### BACKGROUND OF THE INVENTION

Several patents, patent applications and publications are cited in this description in order to more fully describe the state of the art to which this invention pertains. The entire disclosure of each of these patents, patent applications and publications is incorporated by reference herein.

Polyesters are a group of polymers made by reacting diol moieties with diacid moieties. They are widely used in packaging and in the performance polymer domain.

A group of polyesters that has found widespread use in applications requiring resilience and elasticity are the copolyetheresters. Copolyetheresters are a group of elastomeric polyesters having hard segments comprising polyester blocks and soft segments comprising long-chain diols. They are widely used in applications in which resilience and elasticity are required.

A typical copolyetherester is made by reacting one or more diacid moieties with a short-chain diol and a long-chain poly(alkylene oxide)diol.

Copolyetheresters show excellent elasticity, maintenance of mechanical properties at low temperature and good fatigue performance. However, they typically are adversely affected by organic solvents, high- and low-pH, water, show moderate abrasion resistance, cut resistance, creep under high loads at elevated temperature and poor compression set, as compared to traditional thermoset elastomers.

Tavares et al., in US patent publication US2014/0046002, describe a method for forming cross-linked copolyesters that address some of these drawbacks. The method involves mixing in the melt a thermoplastic copolyester, a monomeric diisocyanate and a mixture of two diamines such as 4,4′-methylene-bis-(3-chloro-2,6-diethylaniline) and diethyl 2,4-toluene-diamine. The molten mixture is then injection molded into a mold cavity to form a cross-linked copolyester article. The articles are said to have improved resistance to deformation when subjected to prolonged tension or compression loading. While the properties of the cross-linked material are excellent, the method suffers the drawback that the manufacturer of the article (i.e. extrusion and injection molders) must store and work with diisocyanate. Extrusion and injection molders are typically not equipped to deal with diisocyanates, which are moisture sensitive and which present respiratory hazards.

### SUMMARY OF THE INVENTION

In a first aspect, the invention provides a method for producing a cross-linked polyester article, comprising the steps:
(1) creating a molten blend of at least one polyester, a diisocyanate having a boiling point of greater than 200° C. at 1-10 wt %, an aromatic diamine having a boiling point of greater than 200° C. at 0.5-10 wt %, where the weight percentages are based on the weight of the polyester(s);
(2) forming the molten blend and allowing it to solidify to a solidified cross-linked polyester;
(3) re-melting the solidified cross-linked polyester; and
(4) forming a cross-linked polyester article.

In a second aspect, the invention provides a cross-linked polyester resulting from the reaction of at least one polyester and a diisocyanate having a boiling point of greater than 200° C. (preferably at 1-10 wt %, based on the weight of the polyester(s)) and an aromatic diamine having a boiling point of greater than 200° C. (preferably at 0.5-10 wt %, based on the weight of the polyester(s)) in extruded form, preferably pellets.

In a third aspect, the invention provides a cross-linked polyester resulting from the reaction of at least one polyester and a diisocyanate having a boiling point of greater than 200° C. (preferably at 1-10 wt %, based on the weight of the polyester(s)) and an aromatic diamine having a boiling point of greater than 200° C. (preferably at 0.5-10 wt %, based on the weight of the polyester(s)) in the form of granules or flakes.

In a fourth aspect, the invention provides a method for producing a cross-linked copolyetherester article, comprising the steps:
(1) creating a molten blend of at least one copolyetherester, a diisocyanate having a boiling point of greater than 200° C. at 1-10 wt %, an aromatic diamine having a boiling point of greater than 200° C. at 0.5-10 wt %, where the weight percentages are based on the weight of the copolyetherester(s);
(2) forming the molten blend and allowing it to solidify to a solidified cross-linked copolyetherester;
(3) re-melting the solidified cross-linked copolyetherester; and
(4) forming a cross-linked copolyetherester article.

In a fifth aspect, the invention provides a cross-linked copolyetherester resulting from the reaction of at least one copolyetherester and a diisocyanate having a boiling point of greater than 200° C. (preferably at 1-10 wt %, based on the weight of the polyester(s)) and an aromatic diamine having a boiling point of greater than 200° C. (preferably at 0.5-10 wt %, based on the weight of the polyester(s)) in extruded form, preferably pellets.

In a sixth aspect, the invention provides a cross-linked copolyetherester resulting from the reaction of at least one copolyetherester and a diisocyanate having a boiling point of greater than 200° C. (preferably at 1-10 wt %, based on the weight of the polyester(s)) and an aromatic diamine having a boiling point of greater than 200° C. (preferably at 0.5-10 wt %, based on the weight of the polyester(s)) in the form of granules or flakes.

### DETAILED DESCRIPTION OF THE INVENTION

### Definitions and Abbreviations

MDI 4,4′-diphenylmethane diisocyanate
MCDEA 4,4.-Methylenebis(3-Chloro-2,6-Diethylaniline)
PBT poly(butylene terephthalate)
PET poly(ethylene terephthalate)
PPT poly(propylene terephthalate)
PTMEG polytetramethylene ether glycol
Copolyetherester or TPE thermoplastic elastomer arising from the reaction of at least one diol, at least one diacid and at least one poly(alkylenoxide)diol
Simple polyester a polyester made from at least one C₂-C₁₀ diol and at least one diacid, and not containing appreciable amounts of poly(alkyleneoxide)diol

The inventors have surprisingly found that when a polyester, in particular a copolyetherester, is cross-linked with a diisocyanate having a boiling point of greater than 200° C. and an aromatic diamine having a boiling point of greater than 200° C., the material shows the benefits of cross-linking, however, the cross-linking is reversible at melt temperatures, meaning the resulting cross-linked product can be re-melted and further processed like a thermoplastic material. On re-solidification, the desired properties of a cross-linked material are restored. This is remarkable and entirely unexpected for a cross-linked material.

Significant property improvements in properties/advantages typically arise from cross-linking (as exemplified by Tavares et al., in U.S. Patent Appln. Publn. No. US2014/0046002). However, typical cross-linked materials suffer the disadvantage that the final article is not recyclable either at end of use or immediately as regrind or scrap.

As mentioned previously, Tavares et al. describe a method in which TPE is melt-blended with MDI and MCDEA and directly injection molded. This is called the direct process because the cross-linked article is shaped directly from the melt. Cross-linking occurs as the part is injection molded or extruded. The result is a cross-linked copolyetherester that exhibits the properties of a cross-linked material, such as being insoluble in an organic solvent, such as 1,1,2,2-tetrachloroethane.

Surprisingly, the inventors have found that it is possible to perform thermoplastic melt processing steps on these cross-linked polyesters, in particular TPE's. This process, in which the cross-linked material is re-melted and further processed to yield a cross-linked article is called the indirect method. In the context of the present application the expressions “indirect”, “indirect method” and “indirect process” refer to the method of the invention.

It is possible to isolate polyester, in particular TPE, modified by diisocyanate and diamine in a form that can easily be reprocessed, either by grinding up parts that have been formed by the direct process or by performing the reaction of polyester, in particular TPE with diisocyanate and diamine in a traditional melt compounding step and making pellets, e.g. using a single or twin-screw extrusion process.

Reprocessing the reacted product can be done using traditional melt processing techniques such as re-melting followed by injection molding, extrusion or blow-moulding. The properties of articles made using this indirect process are shown to be essentially indistinguishable from those made from the direct process.

The reversible nature of the cross-linking means not only that the cross-linked material can be recycled numerous times, but that the polyester, in particular copolyetherester, can be cross-linked at the polymer manufacturing site and extruded into granules, pellets, flakes or other transportable and storable form, and used by extrusion and injection molders like a thermoplastic material. This has the substantial advantage that the injection molder need not handle or store moisture-sensitive diisocyanate. The handling of moisture-sensitive diisocyanate can be done at a resin manufacturer's facility, which is optimized for handling such materials, as opposed to risking exposure of the diisocyanate to moisture during storage or in a molding shop, which may lead to poorly controlled cross-linked product and potential exposure to toxic by-products.

Additionally, isocyanates are known to present respiratory hazards whether in the form of particulates, vapors or aerosols. Using the method of the invention means that these materials can be handled by the resin manufacturer using appropriate engineering controls (local ventilation, appropriate operator monitoring and protective equipment) as opposed to pushing this responsibility to the less-expert and less-well-equipped downstream processor. Since the diisocyanate and diamine are already present in the granules, pellets or flakes and indeed reacted with the polymer backbone, variability due to moisture exposure is essentially eliminated, and hazards for handlers of the resin are also essentially eliminated.

The method of the invention also eliminates the need for part manufacturers to blend powders and pellets and accurately meter them into a molding machine. Problems in accuracy can result in variable and unpredictable properties in the cross-linked article.

The method of the invention means that the initial melt-processing of the polyester, in particular copolyetherester, with diisocyanate and diamine can occur in equipment optimized for mixing and vacuum stripping reaction byproducts, thereby allowing the part manufacturer to work with the pre-reacted product without the concern of increased porosity which can occur if reaction gases are trapped in an injection mold.

In a second aspect, the invention provides a cross-linked polyester, in particular a copolyetherester, in extruded form, resulting from step (2) or step (4) of the method of the invention. In a preferred embodiment, the extruded form is pellets. Pellets are made by two main methods:

1. The polymer mixture is extruded though a die in the form of strands directly underwater and relatively quickly cut by a blade. In this method, the strand is partially deformed depending on its viscosity and the cutting speed. As a result, lens-shaped pellets are formed. These typically have a diameter of from 2-6 mm, preferably 3-4 mm, and a thickness of 1-5 mm, preferably 2-3 mm. In a preferred embodiment, the pellets have a diameter of 3-4 mm and a thickness of 2-3 mm.

2. The polymer mixture is extruded though a die in the form of strands cooled in a water bath such that they are fully solidified before cutting by a pelletizer. The result is short strands. These typically have a diameter of from 2-6 mm, preferably 3-4 mm, and a length of 3-7 mm, preferably 4-5 mm. In a preferred embodiment, the pellets have a diameter of 3-4 mm and a length of 4-5 mm.

In preferred embodiments the pellets have the following dimensions:

1. A diameter of from 2-6 mm, preferably 3-4 mm, and a thickness of 1-5 mm, preferably 2-3 mm. Particularly preferably, the pellets have a diameter of 3-4 mm and a thickness of 2-3 mm.

2. A diameter of from 2-6 mm, preferably 3-4 mm, and a length of 3-7 mm, preferably 4-5 mm. Particularly preferably, the pellets have a diameter of 3-4 mm and a length of 4-5 mm.

The pellets of cross-linked polyester, in particular copolyetherester, are a convenient form for storage and transport and can be re-melted and shaped as needed to form shaped articles, such as by injection moulding or extrusion.

In a third aspect, the invention provides a cross-linked polyester, in particular copolyetherester, resulting from step (2) or step (4) of the method of the invention in the form of granules, powder or flakes. After melt-blending at least one polyester, in particular copolyetherester, and a diisocyanate having a boiling point of greater than 200° C. and an aromatic diamine having a boiling point of greater than 200° C., the cross-linked polyester, in particular copolyetherester, is ground or shaved to yield granules, powder or flakes.

The polyester that may be used in the method or cross-linked polymer of the invention is any polymer that results from reacting at least one diol with at least one diacid. It is understood that the expression “diacid” refers to esters and activated forms of a diacid moiety, such as acyl dihalides or diesters (e.g. dimethyl esters). For example, references to terephthalate, terephthalic acid include esters of terephthalic acid, such as dimethyl terephthalate, and terephthaloyl dihalides such as terephthaloyl dichloride.

For simple polyesters, preferred diols are selected from C₂-C₆ diols, and particularly preferred diols are selected from ethylene glycol, propane diol, butane diol and mixtures thereof.

For simple polyesters, preferred diacids are selected from aromatic diacids, particularly preferably terephthalate, iso-phthalate and mixtures thereof. Particularly preferred is terephthalate.

In a particularly preferred embodiment, the at least one polyester is selected from those made from terephthalic acid as the diacid, and ethylene, propylene or butylene glycol, or mixtures of these as the diol. Even more particularly preferably, the polyester is selected from PPT, PBT and PET.

The copolyetherester that may be used in the method or cross-linked polymer of the invention is any copolyetherester that results from reacting at least one diol, at least one diacid and at least one poly(alkyleneoxide)diol. It is understood that the expression “diacid” refers to esters and activated forms of a diacid moiety, as described in detail above with respect to polyesters.

Preferred diols are selected from C₂-C₆ diols, and particularly preferred diols are selected from ethylene glycol, propane diol, butane diol and mixtures thereof.

Preferred diacids are selected from aromatic diacids, particularly preferably terephthalate, iso-phthalate and mixtures thereof. Particularly preferred is terephthalate.

Preferred poly(alkyleneoxide) diols are selected from poly(ethyleneoxide)diol, poly(trimethyleneoxide)diol, poly(tetramethyleneoxide)diol, poly(propyleneoxide)diol, any of these that have been end-capped, for example with poly(ethyleneoxide)diol, and mixtures and copolymers thereof. “End-capped” poly(alkyleneoxide) diols are block copolymers of the form “HO-poly(alkyleneoxide) 1-poly(alkyleneoxide) 2-OH” or “HO-poly(alkyleneoxide) 1-poly(alkyleneoxide) 2-poly(alkyleneoxide) 1-OH”. The “end caps” may be the same, or they may be different poly(alkyleneoxide)s.

The poly(alkyleneoxide) diol is not limited in terms of chain length, and preferably has a molecular weight of from 500 to 4,000 Da, more preferably from 700 to 3,000 Da, particularly preferably 1,000 to 2,000 Da, specifically 1,000 or 1,400 or 2,000 Da. Preferred poly(alkyleneoxide)diols are selected from poly(tetramethyleneoxide)diol (PTMEG) and poly(propyleneoxide)diol, end-capped, for example with poly(ethyleneoxide)diol. A particularly preferred poly(alkyleneoxide)diol is poly(tetramethyleneoxide)diol (PTMEG), more particularly preferably PTMEG with a molecular weight of 1,000-2,000 g/mol. More particularly preferred are PTMEG with a molecular weight of 1,000, 1,400 or 2,000 g/mol. Also particularly preferred are poly(ethyleneoxide)-capped poly(propyleneoxide)diols with a molecular weight of 2,150 to 2,500 g/mol.

In a particularly preferred embodiment the at least one copolyetherester is selected from those made from terephthalic acid as the diacid, butane and/or propane diol as the diol and poly(tetramethyleneoxide)diol (PTMEG) and/or poly(propyleneoxide)diol, end-capped, for example with poly(ethyleneoxide)-diol as the poly(alkyleneoxide) diol. Even more particularly preferably the copolyetherester is selected from those made from terephthalic acid, butane diol and PTMEG.

Preferred copolyetheresters have from 7 to 80 weight percent of copolymerized units of poly(alkyleneoxide)diol, particularly 7 to 80 weight percent PTMEG, based on the total weight of the copolyetherester, the remainder of the weight percentage of the copolyetherester being made up of copolymerized units of diacids and diols, such that the sum of the weight percentages of the copolymerized units in the copolyetheresters is 100 wt %.

Preferred copolyetheresters comprise PTMEG having an average molecular weight of at or about 1,000-2,000 g/mol, particularly preferably at or about 2,000 g/mol, at or about 1,400 g/mol, or at or about 1,000 g/mol.

Particularly preferred is a copolyetherester comprising at or about 72.5 weight percent of PTMEG having an average molecular weight of at or about 2,000 g/mol as polyether block segments, the weight percentage being based on the total weight of the copolyetherester elastomer, the short chain ester units of the copolyetherester being PBT segments.

Also particularly preferred is a copolyetherester comprising about 35.3 weight percent of PTMEG having an average molecular weight of about 1,000 g/mol as polyether block segments, the weight percentage being based on the total weight of the copolyetherester elastomer, the short chain ester units of the copolyetherester being PBT segments.

Also suitable for use in the invention are blends of simple polyesters and copolyetheresters, particularly preferably blends of PET, PPT and/or PBT with a copolyetherester. Examples include:
1. PBT blended with a copolyetherester having from 7 to 80 weight percent of poly(alkyleneoxide)diol soft segment;
2. PBT blended with a copolyetherester having PTMEG as soft segment;
3. PBT blended with a copolyetherester having from 7 to 80 weight percent PTMEG as soft segment;
4. PBT blended with a copolyetherester comprising PTMEG having an average molecular weight of at or about 1,000-2,000 g/mol, particularly preferably at or about 2,000 g/mol, at or about 1,400 g/mol, or at or about 1,000 g/mol;
5. PBT blended with a copolyetherester comprising at or about 72.5 weight percent of PTMEG having an average molecular weight of at or about 2,000 g/mol as polyether block segments, the weight percentage being based on the total weight of the copolyetherester elastomer, the short chain ester units of the copolyetherester being PBT segments;
6. PBT blended with a copolyetherester elastomer comprising about 35.3 weight percent of PTMEG having an average molecular weight of about 1,000 g/mol as polyether block segments, the weight percentage being based on the total weight of the copolyetherester elastomer, the short chain ester units of the copolyetherester being PBT segments.

The at least one polyester, in particular copolyetherester, is preferably dried before adding the cross-linking agents (i.e. the diisocyanate and the diamine), as this reduces hydrolysis of polyester, in particular copolyetherester, itself as well as hydrolysis of the diisocyanate, resulting in more predictable and reproducible cross-linking. Drying can be effected by heating the at least one polyester, in particular copolyetherester, to below its melting point under dry conditions, for example under a stream of dry air or a dry inert gas, or under vacuum.

The cross-linking agents are at least one diisocyanate and at least one diamine. The diisocyanate is selected from those that have a boiling point of at least 200° C., as this prevents boil-off during melt-processing. More preferably the diisocyanate has a boiling point greater than 250° C., more particularly preferably greater than 300° C. Preferred diisocyanates are aromatic diisocyanates having boiling points greater than 200° C. Preferred diisocyanates are solid at room temperature. More preferred diisocyanates are selected from 4,4′-diphenylmethane diisocyanate (“MDI”), 2,4′-diphenyl-methane diisocyanate, 2,2′-diphenylmethane diisocyanate, toluene diisocyanate, hexamethylene diisocyanate, naphthalene diisocyanate, and mixtures and polymers of any of these.

A particularly preferred diisocyanate is 4,4′-diphenylmethane diisocyanate (“MDI”).

The process of the invention requires an aromatic diamine having a boiling point of greater than 200° C. Preferred diamines are solid at room temperature. Examples are diethyl 2,4-toluene diamine, methylenedianiline, 4,4′-Methylenebis(2,6-diethylaniline), 4,4′-Methylenebis(2,6-dimethylaniline), 4,4′-Methylene-bis(2-chloroaniline), 4,4′-Methylene-bis(2-methylaniline), 4,4′-ethylenedianiline, 4,4′-Methylenebis-(O-Chloroaniline), 4,4′-methylenebis-(3-chloro-2,6-diethylaniline) (“MCDEA”), and mixtures of these. A particularly preferred diamine is MCDEA.

A particularly preferred combination is MDI as diisocyanate and MCDEA as diamine.

The diisocyanate, preferably MDI, is preferably used at 1 to 10 wt % with respect to the at least one polyester, in particular copolyetherester, more preferably at 2 to 8 wt %, more particularly preferably at 3 to 6 wt %, most preferably at 5 wt %.

The diamine, preferably MCDEA, is preferably used at 0.5 to 10 wt % with respect to the at least one polyester, in particular copolyetherester, more preferably at 1 to 3 wt %, most preferably at 2.5 wt %.

Preferably the diisocyanate is used in molar excess with respect to the diamine. Preferably the molar ratio of the diisocyanate to diamine is 4:1 to 1.5:1, more preferably 2:1.

Preferably the wt % ratio of diisocyanate to diamine is 4:1 to 1.5:1, more preferably 2:1.

Preferred amounts of diisocyanate and diamine (with respect to the at least one polyester, in particular copolyetherester) are:

8 wt % diisocyanate, preferably MDI, to 4 wt % diamine, preferably MCDEA

5 wt % diisocyanate, preferably MDI, to 2.5 wt % diamine, preferably MCDEA

For simple polyesters, for example PET, PPT and PBT, and stiffer copolyetheresters, for example those having a soft segment [poly(alkyleneoxide)diol] content of less than 28 wt %, it is preferred that the diisocyanate (preferably MDI) be used at 1-5 wt %, more preferably 2-4 wt %, particularly preferably 3.25 wt %, based on the weight of the polyester and/or copolyetherester.

For simple polyesters, for example PET, PPT and PBT, and stiffer copolyetheresters, for example those having a soft segment [poly(alkyleneoxide)diol] content of less than 28 wt % it is preferred that the diamine (preferably MCDEA) be used at 0.5-4 wt %, more preferably 1-3 wt %, particularly preferably 2 wt %, based on the weight of the polyester and/or copolyetherester.

For simple polyesters, for example PET, PPT and PBT, and stiffer copolyetheresters, for example those having a soft segment [poly(alkyleneoxide)diol] content of less than 28 wt % a preferred combination of diisocyanate and diamine is 3.25 wt % diisocyanate (preferably MDI) and 2 wt % diamine (preferably MCDEA), based on the weight of the polyester and/or copolyetherester.

For softer copolyetheresters, for example those having a soft segment [poly(alkyleneoxide)diol] content of 28 wt % or greater, it is preferred that the diisocyanate (preferably MDI) be used at 1-7 wt %, more preferably 2-6 wt %, particularly preferably 5 wt %, based on the weight of the polyester and/or copolyetherester.

For softer copolyetheresters, for example those having a soft segment [poly(alkyleneoxide)diol] content of 28 wt % or greater, it is preferred that the diamine (preferably MCDEA) be used at 0.5-4 wt %, more preferably 1-3 wt %, particularly preferably 2.5 wt %, based on the weight of the polyester and/or copolyetherester.

For softer copolyetheresters, for example those having a soft segment [poly(alkyleneoxide)diol] content of 28 wt % or greater, a preferred combination of diisocyanate and diamine is 5 wt % diisocyanate (preferably MDI) and 2.5 wt % diamine (preferably MCDEA), based on the weight of the polyester and/or copolyetherester.

In a preferred embodiment, the diisocyanate is MDI and the diamine is MCDEA. A particularly preferred combination is MDI at 1 to 10 wt % with respect to the at least one polyester, in particular copolyetherester, more preferably at 2 to 8 wt %, more particularly preferably at 3 to 6 wt %, most preferably at 5 wt %, and MCDEA at 0.5 to 10 wt % with respect to the at least one polyester, in particular copolyetherester, more preferably at 1 to 3 wt %, most preferably at 2.5 wt %. Particularly preferred is 5 wt % MDI and 2.5 wt % MCDEA. Particularly preferred is MDI and MCDEA at a ratio of 2:1.

Some preferred formulations for the method or cross-linked polymer of the invention, in which the weight percentages are based on the total weight of the polyester or copolyetherester, are:
1. PBT, 3.25 wt % MDI and 2 wt % MCDEA
2. PPT, 3.25 wt % MDI and 2 wt % MCDEA
3. PET, 3.25 wt % MDI and 2 wt % MCDEA
4. A copolyetherester, having a soft segment [poly(alkyleneoxide)diol] content of less than 28 wt %, 3.25 wt % MDI and 2 wt % MCDEA
5. A copolyetherester, having a soft segment [poly(alkyleneoxide)diol] content of 28 wt % or greater, 5 wt % MDI and 2.5 wt % MCDEA
6. A copolyetherester made from terephthalate, butane diol and PTMEG, having a soft segment [poly(alkyleneoxide)diol] content of less than 28 wt %, 3.25 wt % MDI and 2 wt % MCDEA
7. A copolyetherester made from terephthalate, butane diol and PTMEG, having a soft segment [poly(alkyleneoxide)diol] content of 28 wt % or greater, 5 wt % MDI and 2.5 wt % MCDEA
8. A copolyetherester comprising about 72.5 weight percent of PTMEG having an average molecular weight of about 2,000 g/mol as polyether block segments, the weight percentage being based on the total weight of the copolyetherester elastomer, the short chain ester units of the copolyetherester being PBT segments, 5 wt % MDI and 2.5 wt % MCDEA
9. A copolyetherester comprising about 35.3 weight percent of PTMEG having an average molecular weight of about 1,000 g/mol as polyether block segments, the weight percentage being based on the total weight of the copolyetherester elastomer, the short chain ester units of the copolyetherester being PBT segments, 5 wt % MDI and 2.5 wt % MCDEA
7. PBT blended with a copolyetherester having from 7 to 80 weight percent of poly(alkyleneoxide)diol soft segment, 1-5 wt % MDI and 0.5-3 wt % MCDEA, based on the total weight of the PBT and copolyetherester;
8. PBT blended with a copolyetherester having PTMEG as soft segment, 1-5 wt % MDI and 0.5-3 wt % MCDEA;
9. PBT blended with a copolyetherester having from 7 to 80 weight percent PTMEG as soft segment, 1-5 wt % MDI and 0.5-3 wt % MCDEA;
10. PBT blended with a copolyetherester comprising PTMEG having an average molecular weight of at or about 1,000-2,000 g/mol, particularly preferably at or about 2,000 g/mol, at or about 1,400 g/mol, or at or about 1,000 g/mol, 1-5 wt % MDI and 0.5-3 wt % MCDEA;
11. PBT blended with a copolyetherester comprising at or about 72.5 weight percent of PTMEG having an average molecular weight of at or about 2,000 g/mol as polyether block segments, the weight percentage being based on the total weight of the copolyetherester elastomer, the short chain ester units of the copolyetherester being PBT segments, 1-5 wt % MDI and 0.5-3 wt % MCDEA, based on the total weight of the PBT and copolyetherester;
12. PBT blended with a copolyetherester elastomer comprising about 35.3 weight percent of PTMEG having an average molecular weight of about 1,000 g/mol as polyether block segments, the weight percentage being based on the total weight of the copolyetherester elastomer, the short chain ester units of the copolyetherester being PBT segments, 1-5 wt % MDI and 0.5-3 wt % MCDEA, based on the total weight of the PBT and the copolyetherester.

In the method or cross-linked polymer of the invention, the at least one polyester, in particular copolyetherester, the diisocyanate and the diamine are blended in molten state to create a homogeneous blend. This is typically done in a single or twin-screw extruder. The order of mixing is not particularly limited. In a preferred embodiment, the at least one polyester, in particular copolyetherester, is first melted and then the diisocyanate and the diamine are added. In another preferred embodiment, the polymer in solid form, for example as pellets or granules, is mixed with the diisocyanate and diamine as a dry blend. In another preferred embodiment, the diisocyanate and/or diamine are mixed with pellets of the polyester, in particular copolyetherester, at a temperature at which the polyester, in particular copolyetherester, is still solid, but which is warm enough to melt the diisocyanate and/or the diamine. This produces a dry blend in which one or both of the cross-linking agents form a coating on the pellets.

The dry blend is fed into a compounding device, such as a single or twin-screw extruder to melt-mix the ingredients and cause cross-linking. The temperature of the extruder must be above the melting temperature of the at least one polyester, in particular copolyetherester, preferably it is from 5 to 70° C. above the melting point of the at least one polyester, in particular copolyetherester. The residence time in the melt is preferably long enough that the at least one polyester, preferably copolyetherester, the diisocyanate and the diamine become a homogeneous blend, but not so long that the melt viscosity increases to the point that shaping becomes difficult. Preferably the residence time is at least 30 seconds, more preferably at least 90 seconds.

The method may also comprise an additional step (2′) in which the cross-linked polyester, in particular copolyetherester, is subjected to a post-curing step consisting of heating to 100 to 150° C., preferably 120° C. for a period of from 6 to 24, preferably 12 hours, after step (2) and before step (3).

Cross-linking of the polymer begins as soon as the diisocyanate and diamine are added to the melt. As soon as the mixture is homogenous it may be shaped into any desired form. The molten mass of cross-linked polymer in step (2) may be shaped into any form. Preferred for transport, storage and ease of re-melting for further processing are pellets, granules, powders and flakes. Pellets are typically made by extruding strands through a die, followed by cooling (for example by quenching in water) and subsequent cutting into pellets. Flakes may be made by shaving or grinding cross-linked material in any form. This includes of course regrinding moulded articles made by the direct process or indirect process, or waste or rejects resulting from the moulding process. Pellets, granules and flakes can be easily packaged (for example in bags), and stored or transported to article manufacturers. Thus, the method of the invention may additionally comprise a step (2″), of grinding or shaving the solidified cross-linked copolyetherester to form flakes, powder or granules. Optional step (2″) is carried out after step (2) or step (2′), and before step (3). Alternatively, step (2″) may be carried out after step (4), and the ground or shaved cross-linked polymer cycled back into step (3), thus re-melted and formed again.

In re-processing or recycling of the cross-linked polymer, the polymer is reduced to a suitable form that it can be readily fed into extruders for re-melting and further processing, such as powder or flakes.

Recycling in this way is generally not possible for cross-linked materials. The fact that the method of the invention provides material that is cross-linked and exhibits all the advantages of cross-linked material, and yet allows recycling is surprising, and offers the advantages of improved part yield from resin (waste can be recycled into parts), reduced environmental impact of plastic waste, and reduced cost to molders.

Powder in this context is small particles having an average particle size of from 75 to 750 microns with >95% passing through a 1,000 micron sieve.

Flakes in this context are pieces of polymer having a size of 4-8 mm, flake thickness 0.5-2 mm, flake size≥8 mm≤1% wt, flake size 2-4 mm≤20% wt, flake size≤2 mm≤1% wt. Alternatively, flakes are pieces of polymer having a thickness to width ratio of 1:4 to 1:12 and average dimensions of 2-10 mm by 2-10 mm in the plane.

The method of the invention also includes, in one embodiment, the recycling of shaped articles made by the direct method or indirect method. In such embodiments, the forming in step (2) or step (4) is, inter alia, extrusion, injection-moulding, compression-moulding or blow-moulding to form an article. After or before use, the resulting article can be subjected to step (2″), detailed above, to render it in a form that can be readily stored, transported and re-melted for reprocessing in steps (3) and (4).

In one aspect, the invention provides a cross-linked polyester, in particular copolyetherester, resulting from the reaction of at least one polyester, in particular copolyetherester, and a diisocyanate having a boiling point of greater than 200° C. and an aromatic diamine having a boiling point of greater than 200° C. in extruded form. The extruded form may be pellets made as described above. The pellets are suitable to be re-melted and processed into a cross-linked shaped article. In a further aspect, the invention provides a cross-linked polyester, in particular copolyetherester, resulting from the reaction of at least one polyester, in particular copolyetherester, and a diisocyanate having a boiling point of greater than 200° C. and an aromatic diamine having a boiling point of greater than 200° C., in which the cross-linked polyester, in particular copolyetherester, is in the form of pellets.

In another aspect, the invention provides a cross-linked polyester, in particular copolyetherester, resulting from the reaction of at least one polyester, in particular copolyetherester, and a diisocyanate having a boiling point of greater than 200° C. and an aromatic diamine having a boiling point of greater than 200° C. in ground form or flakes. The ground polymer (typically called “regrind” in the polymer arts) may be re-melted and processed into a cross-linked shaped article. Ground polymer or flakes are produced by grinding.

When it is desired to form a cross-linked article, the cross-linked polyester, in particular copolyetherester, resulting from step (2) is re-melted, for example in a single or twin-screw extruder and shaped by any method desired, for example, injection moulding, extrusion, blow-moulding. The temperature of the extruder must be above the melting temperature of the at least one polyester, in particular copolyetherester, preferably it is from 5 to 70° C. above the melting point of the at least one polyester, in particular copolyetherester.

The cross-linked polyester, in particular copolyetherester, resulting from step (2) and the cross-linked article resulting from step (4) may be tested for cross-linking by determining their solubility in an organic solvent, such as 1,1,2,2-tetrachloroethane. The cross-linked polymer of step (2) and cross-linked article of step (4) are essentially insoluble in 1,1,2,2-tetrachloroethane, whereas the uncross-linked polymers dissolve.

After step (4), the cross-linked article may be subjected to a post-curing step consisting of heating to 100 to 150° C., preferably 120° C. for a period of from 6 to 24 hours, preferably 12 hours.

The shaped cross-linked article resulting from step (4) has good abrasion-resistance, tensile strength, rebound behaviour, and compression set.

The cross-linked compositions described herein may further comprise additives that include, but are not limited to, one or more of the following components as well as combinations of two or more of these: metal deactivators, such as hydrazine and hydrazide; heat stabilizers; antioxidants; modifiers; colorants; lubricants; fillers (such as glass, mica, barium sulphate, stainless steel, clays) and reinforcing agents; impact modifiers; flow enhancing additives; antistatic agents; crystallization promoting agents; conductive additives; viscosity modifiers; nucleating agents; plasticizers; mold release agents; scratch and mar modifiers; drip suppressants; adhesion modifiers; and other processing aids known in the polymer compounding art. These additives may be added to the polyester or copolyetherester by methods that are known in the art.

In particular, the compositions may comprise poly(dimethylsiloxane) (“PDMS”), preferably at 1-8 wt %, more preferably 2-5 wt % or 3 wt % PDMS, based on the weight of the polyester, particularly copolyetherester. Inorganic fillers, when used, are preferably present at up to 30 wt %, based on the weight of the polyester, particularly copolyetherester. When used, the other additive(s) are preferably present in amounts of about 0.1 to about 20 weight percent, based on the total weight of polyester, in particular copolyetherester. Preferably, no individual other additive is present at a level of more than 5 wt %, based on the total weight of polyester, in particular copolyetherester.

One property that is improved by cross-linking is solvent resistance. Solvent resistance can be measured, for example, by measuring weight gain after soaking in an organic solvent. Weight gain is typically expressed as a percentage (%) based on the original, un-soaked sample.

Another property that is improved by cross-linking is retention of tensile properties after exposure to an organic solvent. Tensile strength can be measured, for example, according to ISO527. Retention of tensile strength is typically reported as a percent with respect to an unexposed sample. Stress at 50% strain can be measured, for example, according to ISO527. Retention of Stress at 50% strain is typically reported as a percent with respect to an unexposed sample.

The shaped cross-linked article is not particularly limited as to application. Some exemplary fields of application for cross-linked copolyetheresters include oil and gas applications. Particularly preferred applications include: mold on rod guides, sucker rod guides, cone packs, 0-rings, gaskets, seals, ski pole stems, housings, conveyor belts, and load bearing wheels.

The following examples are provided to describe the invention in further detail. These examples, which set forth a preferred mode presently contemplated for carrying out the invention, are intended to illustrate and not to limit the invention.

### EXAMPLES

Chemicals:

MDI=4,4′-diphenylmethane diisocyanate

MCDEA=4,4′-Methylenebis(3-Chloro-2,6-Diethylaniline)

Copolyetheresters (“TPE”), all grades had PBT hard segments and PTMEG soft segments.

TPE1 is a copolyetherester elastomer comprising about 72.5 weight percent of PTMEG having an average molecular weight of about 2,000 g/mol as polyether block segments, the weight percentage being based on the total weight of the copolyetherester elastomer, the short chain ester units of the copolyetherester being PBT segments.

TPE2 is a copolyetherester elastomer comprising about 35.3 weight percent of PTMEG having an average molecular weight of about 1,000 g/mol as polyether block segments, the weight percentage being based on the total weight of the copolyetherester elastomer, the short chain ester units of the copolyetherester being PBT segments.

To demonstrate the method or cross-linked polymer of the invention, copolyetheresters were cross-linked by melt-blending in an extruder: copolyetherester, MDI and MCDEA, with cross-linked test pieces being formed immediately by injection molding directly from the extruder (conventional comparative method, also called the Direct Method because the cross-linking and moulding occur essentially simultaneously). These test pieces were compared with test pieces made by re-melting cross-linked copolyetherester flakes followed by injection molding into test pieces (method of the invention, also call the Indirect Method). As a further comparison, un-cross-linked copolyetherester was injection molded into test pieces.

### Preparation of Samples

Conventional Comparative Method (Direct Method)

TPE's were oven-dried for 16 hr in an air oven maintained at 80° C.

Samples:
(1) TPE1
(2) TPE1+5% MDI+2.5% MCDEA
   (a) TPE1 was removed from the dryer and cooled to a pellet temperature of approximately 60° C.
   (b) 20 lb TPE1 was added to a canco pail, together with 1 lb MDI, the lid was attached and the canco pail was tumbled for 30 minutes to allow the MDI flake to melt and coat the TPE pellets and freeze as the pellets cool below 40° C.
   (c) The lid was removed from the canco pail, 0.5 lb MCDEA was added, the lid was reattached and the canco pail was tumbled for 10 minutes to ensure mixing of the MCDEA with the MDI coated TPE1 pellets. This formed a dry blend that was fed to the injection moulding machine.
(3) TPE2
(4) TPE2+5% MDI+2.5% MCDEA
   A dry blend was prepared the same way as described above with respect to TPE1.

An injection moulding machine was used to melt-blend the dry blends and directly prepare 6″×6″×⅛″ plaques as test pieces.

A subset of plaques 2 and 4 were heat treated by heating in an air circulating oven for 12 hr at 250° F. These plaques were marked as 2H and 4H.

Compression set buttons (1″ discs) and ISO 5A tensile bars were die cut from these plaques.

### Method of the Invention (Indirect Method)

TPE's were oven dried for 16 hr in an air oven maintained at 80° C.

Samples:
(A) TPE1
(B) TPE1+5% MDI+2.5% MCDEA
   (a) TPE was removed from the dryer and cooled to a pellet temperature of approximately 60° C.
   (b) 18.5 lb TPE1 was added to a canco pail, together with 1 lb MDI. The lid was attached and the canco pail was tumbled for 30 minutes to allow the MDI flake to melt and coat the TPE pellets and freeze as the pellets cool below 40° C.
   (c) The lid was removed, 0.5 lb MCDEA was added to the canco pail, the lid was reattached and the canco pail was tumbled for 10 minutes to ensure mixing of the MCDEA with the MDI coated TPE1 pellets. This formed a dry blend that was fed to the injection moulding machine.
(C) Cross-linked material from (B) above, ground.
(D) TPE2
(E) TPE2+5% MDI+2.5% MCDEA
   A dry blend was prepared the same way as described above with respect to TPE1.
(F) Cross-linked material from (E) above, ground to flakes.

Compounding:

Compounding of the dry blends B and E was performed in a Werner & Pfleiderer 30 mm co-rotating twin screw extruder with a length to barrel ratio of 30:1 containing a medium work screw running@250 rpm. The dry blend was continuously metered to the extruder at 25 lb/yr using a K-tron loss in weight feeder with a nitrogen purge on the feed hopper. The feed throat and initial barrel were not heated, with the remaining barrels set to 230° C. Vacuum was applied towards the end of the extruder. The extruder was fitted with a standard 8-0 transition piece and a single hole 3/16″ die plate. The strand from the extruder was quenched in a water trough before passing over air knives to remove surface water from the solid strand then pelletized using a strand cutter.

Injection Moulding:

Pellets to be injection molded were dried for 16 hr in an air circulating oven at 80° C.

A Nissei FN4000 molding machine was used to injection mold ISO 5A tensile bars, and, on a separate day, 3″×5″×⅛″ plaques.

Injection molded ISO 5A microtensile bars and 3″×5″×⅛″ plaques were molded from TPE1 (A) and TPE2 (D) using the same equipment.

An Arburg molding machine was used to injection mold 3″×5″×⅛″ plaques from flake from grinding the parts made from (2) with the newly formed parts marked as (C) and from flake from grinding the parts made from (4) with the newly formed parts marked as (F).

A subset of plaques and tensile bars B, C, E and F were heat treated by heating in an air circulating oven for 12 hr at 250° F. These heat-treated parts are marked as BH, CH, EH & FH.

The various test pieces are summarized in Table 1. The production of the various samples is depicted in FIG. 1.

TABLE 1
Summary of test pieces

| Sample | Type | Description | Method |
|---|---|---|---|
| 1 | Comparative | Plaques molded from TPE1 (uncross-linked) | Not cross-linked |
| 2 | Comparative | Plaques molded directly from TPE1 cross-linked | direct |
| | | with 5 wt% MDI + 2.5 wt % MCDEA | |
| 2H | Comparative | Plaques molded directly from TPE1 cross-linked | direct |
| | | with 5 wt% MDI + 2.5 wt % MCDEA, heat-treated | |
| | | for 12 hr at 250° F. | |
| 3 | Comparative | Plaques molded from TPE2 (uncross-linked) | Not cross-linked |
| 4 | Comparative | Plaques molded directly from TPE2 cross-linked | direct |
| | | with 5 wt% MDI + 2.5 wt % MCDEA | |
| 4H | Comparative | Plaques molded directly from TPE2 cross-linked | direct |
| | | with 5 wt % MDI + 2.5 wt % MCDEA, heat-treated | |
| | | for 12 hr at 250° F. | |
| A | Comparative | Plaques molded from TPE1 (uncross-linked) | Not cross-linked |
| B | Invention | Plaques molded from re-melted pellets made by | indirect |
| | | extrusion of TPE1 cross-linked with 5 wt % MDI + | |
| | | 2.5 wt % MCDEA | |
| BH | Invention | Heat-treated plaques molded from re-melted | indirect |
| | | pellets made by extrusion of TPE1 cross-linked | |
| | | with 5 wt % MDI + 2.5 wt % MCDEA | |
| C | Invention | Plaques made from re-melted material from 2 | indirect |
| | | (TPE1 cross-linked with 5 wt % MDI + 2.5 wt % | |
| | | MCDEA) | |
| CH | Invention | Heat-treated plaques made from re-melted | indirect |
| | | material from 2 (TPE1 cross-linked with 5 wt % | |
| | | MDI + 2.5 wt % MCDEA) | |
| D | Comparative | Plaques molded from TPE2 (uncross-linked) | Not cross-linked |
| E | Invention | Plaques molded from re-melted pellets made by | indirect |
| | | extrusion of TPE2 cross-linked with 5 wt % MDI + | |
| | | 2.5 wt % MCDEA | |
| EH | Invention | Heat-treated plaques molded from re-melted | indirect |
| | | pellets made by extrusion of TPE2 cross-linked | |
| | | with 5 wt % MDI + 2.5 wt % MCDEA | |
| F | Invention | Plaques made from re-melted flakes from 4 | indirect |
| | | (TPE2 cross-linked with 5 wt % MDI + 2.5 wt % | |
| | | MCDEA) | |
| FH | Invention | Heat-treated plaques made from re-melted flakes | indirect |
| | | from 4 (TPE2 cross-linked with 5 wt % MDI + 2.5 | |
| | | wt % MCDEA) | |

Solvent Resistance

The retention of mechanical properties after exposure to toluene and 1,1,2,2-tetrachloroethane (“TCE”) was used to assess the suitability of the cross-linked parts for use in harsh environments in which molded articles might be exposed to organic solvents such as in oil and gas applications.

The following test samples were evaluated for tensile strength: 1, A, B, C, 2H, BH & CH (TPE1 based), and 3, D, E, F, 4H, EH & FH (TPE2 based).

Establishing a Baseline

Baseline tensile properties were measured by pulling the molded ISO 5A bars in a single station tensile frame from Instron, using a test speed of 50 mm/min and other test parameters as outlined in ISO 527-1:2012 with the exception that nominal strain calculated from tensile grip separation was used into of strain measured using an extensometer.

Toluene Exposure Testing

Each sample was weighed then immersed in room temperature toluene for 24 hr. Once the exposure was completed the sample was patted dry with a paper towel and then weighed again, then sealed in an air tight Ziploc bag. Within 60 minutes the tensile properties of the sample were measured using the same method as for the baseline data.

The results obtained for TPE1 based samples are listed in Table 2. The results for TPE2 based samples are listed in Table 3.

TABLE 2
weight gain, tensile strength retention and stress at 50% strain retention
after soaking for 24 hr in toluene for samples based on TPE1

| | Weight [g] | | | Tensile Strength [MPa] | | | Stress @ 50% Strain [MPa] | | |
|---|---|---|---|---|---|---|---|---|---|
| | | | gain | | | retention | | | retention |
| Sample | original | exposed | (%) | original | exposed | (%) | original | exposed | (%) |
| 1 (not | 4.269 | 17.099 | 301 | 21.4 | 3.8 | 18 | 5.49 | 0.43 | 8 |
| cross- | | | | | | | | | |
| linked) | | | | | | | | | |
| 2H | 4.362 | 11.790 | 170 | 23.8 | 10.6 | 45 | 5.81 | 2.44 | 42 |
| (direct) | | | | | | | | | |
| A (not | 2.697 | 10.564 | 292 | 21.2 | 3.9 | 18 | 5.43 | 0.42 | 8 |
| cross- | | | | | | | | | |
| linked) | | | | | | | | | |
| B | 2.812 | 8.265 | 194 | 21.7 | 7.0 | 32 | 5.57 | 2.02 | 36 |
| (indirect) | | | | | | | | | |
| BH | 2.741 | 7.568 | 176 | 23.1 | 10.7 | 46 | 5.67 | 2.36 | 42 |
| (indirect) | | | | | | | | | |
| C | 2.876 | 8.321 | 189 | 21.2 | 7.1 | 33 | 5.61 | 1.97 | 35 |
| (indirect) | | | | | | | | | |
| CH | 2.763 | 7.694 | 178 | 23.6 | 10.3 | 44 | 5.71 | 2.52 | 44 |
| (indirect) | | | | | | | | | |

TABLE 3
weight gain, tensile strength retention and stress at 50% strain retention
after soaking for 24 hr in toluene for samples based on TPE2

| | Weight [g] | | | Tensile Strength [MPa] | | | Stress @ 50% Strain [MPa] | | |
|---|---|---|---|---|---|---|---|---|---|
| | | | gain | | | retention | | | retention |
| Sample | original | exposed | (%) | original | exposed | (%) | original | exposed | (%) |
| 3 (not | 4.726 | 6.366 | 35 | 31.3 | 16.6 | 53 | 14.2 | 8.2 | 58 |
| cross- | | | | | | | | | |
| linked) | | | | | | | | | |
| 4H | 4.637 | 5.783 | 25 | 31.3 | 20.8 | 66 | 14.8 | 12.1 | 82 |
| (direct) | | | | | | | | | |
| D (not | 2.954 | 3.969 | 34 | 32.0 | 16.7 | 52 | 14.0 | 8.4 | 60 |
| cross- | | | | | | | | | |
| linked) | | | | | | | | | |
| E | 3.007 | 3.730 | 24 | 29.8 | 20.9 | 70 | 14.6 | 10.8 | 74 |
| (indirect) | | | | | | | | | |
| EH | 2.923 | 3.578 | 22 | 31.3 | 20.8 | 66 | 14.8 | 12.0 | 81 |
| (indirect) | | | | | | | | | |
| F | 3.001 | 3.725 | 24 | 29.2 | 20.9 | 72 | 15.1 | 10.9 | 72 |
| (indirect) | | | | | | | | | |
| FH | 2.996 | 3.688 | 23 | 30.9 | 20.3 | 66 | 15.3 | 12.5 | 81 |
| (indirect) | | | | | | | | | |

The data in Tables 2 and 3 shows that, as expected, materials prepared by directly injection molding cross-linked TPE's (2H, 4H) show significantly improved retention of tensile properties on exposure to toluene as compared to uncross-linked material (1, A, 3, D). Surprisingly, material prepared by the method of the invention, i.e. re-melting cross-linked TPE followed by injection molding (B, BH, C, CH) shows essentially the same or similar improvement as the original cross-linked material. This clearly demonstrates that the cross-linking is reversible, giving material with the advantages of cross-linked TPE with the processibility of a thermoplastic material.

Solvent Resistance (1,1,2,2-tetrachloroethane)

Samples to be Evaluated:

20-30 mg samples were cut from microtensile bars of 1, 2, A, B, C, 2H and BH (TPE1-based), and 3, 4, D, E, F, 4H and EH (TPE2-based).

Each sample was added to a glass vial containing 5 ml 1,1,2,2-tetrachloroethane solvent at room temperature. Samples 1, A, 3 and D (uncross-linked) completely dissolved within 30 minutes. Samples 2, B, C, 2H, BH, 4, E, F, 4H and EH (cross-linked) swelled but did not dissolve after leaving in soak for 48 hr.

These results demonstrate that the material made by reaction of TPE with a diisocyanate and a diamine, whether by the direct or indirect method, is insoluble and therefore cross-linked. Furthermore, the results demonstrate that the cross-linking is reversible, as the samples prepared by the indirect method (method of the invention) are insoluble.

Compression Set

Compression set discs were die cut from 6″×6″×⅛″ plaques of 1, 2H, 3, 4H and from 3″×5″×⅛″ plaques of A, BH, CH, D, EH and FH. It is well known that allowing complete development of crystallinity before starting the compression set test improves results (reduces set) as the crystallinity is developed in the original form rather than under compression. The discs from 1, 3, A and D were annealed for 3 hr at 125° C. The discs of 2H, 4H, BH, CH, EH and FH were not annealed as the heat treatment step of the original plaques already allowed the crystallinity to fully develop.

Compression set method B measurements [ASTM D395-18 method B (70° C., 22 hr)] were performed using 25% constant strain applied in a jig at 70° C. for 22 hr. The original sample height was nominally 0.5 inches, achieved by stacking up 4 discs of each sample. Jig spacers were set at 0.375 inches, providing a constant strain of 25%.

The following results are listed in Tables 4 and 5. A lower set is advantageous when the material is used under compression.

TABLE 4
Compression set measurements for TPE1 based samples

| Sample | Type | Set |
|---|---|---|
| 1 | Uncross-linked (comparative) | 55 |
| 1 [annealed] | Uncross-linked (comparative) | 45 |
| 2H | Cross-linked by direct method | 31 |
| | (comparative) | |
| A | Uncross-linked (comparative) | 55 |
| A [annealed] | Uncross-linked (comparative) | 46 |
| BH | Cross-linked and re-melted | 34 |
| | (invention) | |
| CH | Cross-linked and re-melted | 35 |
| | (invention) | |

TABLE 5
Compression set measurements for TPE2 based samples

| Sample | Type | Set |
|---|---|---|
| 3 | Uncross-linked (comparative) | 59 |
| 3 [annealed] | Uncross-linked (comparative) | 50 |
| 4H | Cross-linked by direct method | 40 |
| | (comparative) | |
| D | Uncross-linked (comparative) | 57 |
| D [annealed] | Uncross-linked (comparative) | 49 |
| EH | Cross-linked and re-melted | 43 |
| | (invention) | |
| FH | Cross-linked and re-melted | 42 |
| | (invention) | |

The data in Tables 4 and 5 shows that, as expected, material prepared by directly injection molding cross-linked TPE's (2H, 4H) shows significantly improved set as compared to uncross-linked material (1, A, 3, D). Surprisingly, material prepared by re-melting cross-linked TPE followed by injection molding shows essentially the same improvement as the original cross-linked material. The clearly demonstrates that the cross-linking is reversible, giving material with the advantages of cross-linked TPE with the processibility of a thermoplastic material.

While certain of the preferred embodiments of this invention have been described and specifically exemplified above, it is not intended that the invention be limited to such embodiments. Various modifications may be made without departing from the scope and spirit of the invention, as set forth in the following claims.

1. A method for producing a cross-linked polyester article, comprising the steps:
(1) creating a molten blend of at least one polyester, a diisocyanate having a boiling point of greater than 200° C. at 1-10 wt %, an aromatic diamine having a boiling point of greater than 200° C. at 0.5-10 wt %, where the weight percentages are based on the weight of the polyester;
(2) forming the molten blend and allowing it to solidify to a solidified cross-linked polyester;
(3) re-melting the solidified cross-linked polyester; and
(4) forming a cross-linked polyester article.

2. The method of claim 1, wherein the diisocyanate is used in molar excess with respect to the diamine.

3. The method of claim 1, wherein the at least one polyester comprises at least one diol and at least one diacid.

4. The method of claim 1, wherein the at least one polyester comprises the following monomers:
a diol selected from ethylene glycol, propylene glycol, butylene glycol and mixtures of these;
a diacid selected from terephthalic acid, iso-terephthalic acid, and mixtures of these.

5. The method of claim 1, wherein the at least one polyester is selected from PET, PPT, PBT and blends of these.

6. The method of claim 1, wherein the diisocyanate is selected from those having a boiling point greater than 300° C.

7. The method of claim 1, wherein the diisocyanate is selected from 4,4′-diphenylmethane diisocyanate (“MDI”), 2,4′-diphenyl-methane diisocyanate, 2,2′-diphenylmethane diisocyanate, toluene diisocyanate, hexamethylene diisocyanate, naphthalene diisocyanate, and mixtures and polymers of any of these; or wherein the diamine is selected from methylenedianiline, 4,4′-Methylenebis(2,6-diethylaniline), 4,4′-Methylenebis(2,6-dimethylaniline), 4,4′-Methylene-bis(2-chloroaniline), 4,4′-Methylene-bis(2-methylaniline), 4,4′-ethylenedianiline, 4,4′-Methylenebis-(0-Chloroaniline), 4,4′-methylenebis-(3-chloro-2,6-diethylaniline) (“MCDEA”), and mixtures of these.

8-10. (canceled)

11. The method of claim 1, wherein the diisocyanate is used at 1 to 10 wt % with respect to the at least one polyester; or wherein the diamine is used at 0.5 to 10 wt % with respect to the at least one polyester.

12. (canceled)

13. The method of claim 1, wherein the diisocyanate is used at 5 wt % and the diamine is used at 2.5 wt %, both with respect to the at least one polyester.

14. The method of claim 1, wherein in step (2) the molten blend is extruded as a strand followed by cutting of the strand such that the solidified cross-linked polyester is in the form of pellets.

15. The method of claim 14, wherein the pellets have the following dimensions:
(1) a diameter of 3-4 mm and a thickness of 2-3 mm; or
(2) a diameter of 3-4 mm and a length of 4-5 mm.

16. The method of claim 1, comprising an additional step (2′) consisting of grinding or shaving the solidified cross-linked polyester to form flakes, powder or granules after step (2) and before step (3).

17. The method of claim 1, wherein the diisocyanate is 5 wt % MDI and the diamine is 2.5 wt % MCDEA, based on the weight of the polyester.

18. The method of any one preceding claim 1, wherein in step (1) the molten blend is maintained at 5 to 70° C. above the melting point of the at least one polyester for at least a period of 30 seconds.

19. A cross-linked polyester resulting from melt-blending at least one polyester and a diisocyanate having a boiling point of greater than 200° C. and an aromatic diamine having a boiling point of greater than 200° C., wherein the cross-linked polyester is in extruded form or in the form of granules, powder or flakes.

20-22. (canceled)

23. A method according to claim 1 for producing a cross-linked copolyetherester article, wherein the polyester is a copolyetherester, and wherein the
molten blend comprises at least one copolyetherester, a diisocyanate having a boiling point of greater than 200° C. at 1-10 wt %, an aromatic diamine having a boiling point of greater than 200° C. at 0.5-10 wt %, where the weight percentages are based on the weight of the copolyetherester.

24. (canceled)

25. (canceled)

26. The method of claim 23, wherein the copolyetherester comprises a copolymerized poly(alkyleneoxide) diol having a molecular weight of 500 to 4,000 Da.

27. The method of claim 23, wherein the copolyetherester comprises the following monomers: butane diol, terephthalic acid and PTMEG.

28-35. (canceled)

36. The method of claim 23, wherein the copolyetherester has a soft segment [poly(alkyleneoxide)diol] content of less than 28 wt % and the diisocyanate is used at 1-5 wt %, or the diamine is used at 0.5-4 wt %, based on the weight of the copolyetherester.

37-44. (canceled)

45. A cross-linked copolyetherester resulting from melt-blending at least one copolyetherester and a diisocyanate having a boiling point of greater than 200° C. and an aromatic diamine having a boiling point of greater than 200° C., wherein the cross-linked copolyetherester is in extruded form or in the form of granules, powder or flakes.

46-59. (canceled)
